(19) United States
(12) Patent Application Publication
(10) Pub. No.: US 2026/0158456 A1
(43) Pub. Date: Jun. 11, 2026

(54) ELECTRODE SLURRY STORAGE DEVICE

(71) Applicant: SAMSUNG SDI CO., LTD., Yongin-si (KR)

(72) Inventor: EUNYEONG PARK, Yongin-si (KR)

(21) Appl. No.: 19/182,029

(22) Filed: Apr. 17, 2025

(30) Foreign Application Priority Data
Oct. 17, 2024 (KR) 10-2024-0141809

(51) Int. Cl. B01F 27/15; B01F 23/50; B01F 27/112; B01F 35/50; B01F 35/90; B01F 35/95; B05C 11/10; H01M 4/04

(52) U.S. Cl. CPC B01F 27/15; B01F 23/565; B01F 27/112; B01F 35/50; B01F 35/95; H01M 4/0404; B01F 2035/99; B05C 11/1042

(57) ABSTRACT

An electrode slurry storage device is provided that improves the efficiency and stability of a manufacturing process of a secondary battery. The electrode slurry storage device includes a chamber in which an object to be mixed is accommodated. The device also includes a rotating part having a side arranged inside the chamber part, configured to rotate around an axis, and being hollow, and a heater arranged inside the rotating part and configured to provide heat inside the rotating part. An operating fluid is accommodated in the rotating part, with a part of the heater being immersed in the operating fluid.

### CROSS-REFERENCE TO RELATED APPLICATION

This application is based on and claims priority under 35 U.S.C. § 119 to Korean Patent Application No. 10-2024-0141809, filed on Oct. 17, 2024, in the Korean Intellectual Property Office, the disclosure of which is incorporated by reference herein in its entirety.

### BACKGROUND

### 1. Field

One or more embodiments relate to an electrode slurry storage device, and more particularly, to an electrode slurry storage device that improves the efficiency or stability of a manufacturing process of a secondary battery.

### 2. Description of the Related Art

With the rapid development of the electrical, electronic, communication and computer industries, the demand for high-performance and safe secondary batteries has rapidly increased. In particular, with the trend toward lightweight, simple, and portable electrical and electronic products, secondary batteries, which are key components, are also required to be lightweight and small size.

In particular, with environmental pollution problems, such as air pollution and noise due to the mass distribution of automobiles and with the need for new forms of energy sources due to the depletion of oil, the need for the development of electric vehicles has increased, and the development of batteries with high output and high energy density is required as the power source for these vehicles.

In response to such demands, one of the high-performance, next-generation, cutting-edge new batteries that has recently received the most attention is a secondary battery wherein lithium is used as a cathode or an anode. Such batteries are getting the attention because of their high energy density and standard reduction potential.

To create cathode and anode plates in a process of manufacturing an electrode assembly for a secondary battery, electrode slurries are coated on aluminum and copper current collectors and then a rolling and slitting process is performed.

It is necessary to prevent the electrode slurry from solidifying before being discharged to the coating device in an electrode slurry storage device that supplies electrode slurry to a coating device of such a current collector.

The above-described information disclosed in this section of the disclosure is intended to improve understanding of the background of the present disclosure and may include information that does not constitute prior art.

### SUMMARY

One or more embodiments provide an electrode slurry storage device that improves the efficiency or stability of a manufacturing process of a secondary battery.

Problems to be solved by the disclosure are not limited to the problems mentioned above, and other problems and advantages of the disclosure that are not mentioned may be understood by the following description and will be more clearly understood by the embodiments of the disclosure.

An electrode slurry storage device according to an embodiment of the disclosure includes a chamber configured to accommodate an object to be mixed, a rotating part having a side arranged inside the chamber part, configured to rotate around an axis, and being hollow, and a heater arranged inside the rotating part and configured to provide heat inside the rotating part, and an operating fluid accommodated in the rotating part, with a part of the heater being immersed in the operating fluid.

In an embodiment, the rotating part may include a rotating body including (i) a cylinder part extending along the axis and connected to the chamber, and (ii) a wing part connected to the cylinder part and extending in a direction away from the axis.

In an embodiment, the rotating body may extend through a surface of the chamber and may be rotatably connected to the chamber.

In an embodiment, an inner periphery surface of the rotating body and the heater may be spaced apart from each other by a preset distance.

In an embodiment, an inner periphery surface of the rotating body and the heater may be in sliding contact.

In an embodiment, the heater may include a heating rod arranged inside the rotating body and be configured to receive power to provide heat to the operating fluid.

In an embodiment, a longitudinal central axis of the heating rod may be parallel to a longitudinal central axis of the rotating body.

In an embodiment, a diameter of the heating rod may be less than an inner diameter of the rotating body.

In an embodiment, a longitudinal central axis of the heating rod may be coaxial with a longitudinal central axis of the rotating body.

In an embodiment, the heater may further include a heating wire wound around an outer periphery surface of the heating rod and configured to receive power supply to thereby provide heat to the operating fluid.

In an embodiment, the rotating body may be rotatable relative to the heating rod by receiving power supply.

In an embodiment, the heating rod may be fixed inside the rotating body such that rotation of the heating rod may be restricted.

In an embodiment, the wing part may be hollow, an internal space of the wing part may be in fluid communication with to an internal space of the cylinder part, and the heater spaced apart from the internal space of the wing part.

An electrode slurry storage device according to another embodiment of the disclosure to solve the technical problem includes a chamber configured to accommodate an object, a heater fixed inside the chamber and configured to receive power to provide a heat to the object to be mixed, and a rotating part arranged inside the chamber and surrounding the heater, the rotating part being rotatable relative to the heater, and part of the heater is immersed in an operating fluid that is accommodated in the rotating part.

In an embodiment, the rotating part comprises a rotating body including (i) a cylinder part extending along the axis and connected to the chamber, and (ii) a wing part connected to the cylinder part and extending in a direction away from the axis.

In an embodiment, the rotating body extends through a surface of the chamber and may be rotatably connected to the chamber.

In an embodiment, the heater may include a heating rod arranged inside the rotating body and configured to receive power to thereby provide heat to the operating fluid.

In an embodiment, a longitudinal central axis of the heating rod may be parallel to a longitudinal central axis of the rotating body.

In an embodiment, a diameter of the heating rod may be less than an inner diameter of the rotating body.

In an embodiment, the wing part may be hollow, an internal space of the wing part may be in fluid communication with an internal space of the cylinder part, and the heater may be spaced apart from the internal space of the wing part.

### BRIEF DESCRIPTION OF THE DRAWINGS

These and/or other aspects will become apparent and more readily appreciated from the following description of the embodiments, taken in conjunction with the accompanying drawings in which:

FIG. 1 is a block diagram of a secondary battery manufacturing system according to an embodiment;

FIG. 2 is a schematic diagram of an electrode slurry storage device and a coating part illustrated in FIG. 1;

FIG. 3 is a perspective view of the electrode slurry storage device illustrated in FIG. 2;

FIG. 4 is a perspective view showing an assembled state of a rotating part, a heating part, an operating fluid, and a sealing part shown in FIG. 3;

FIG. 5 is a cross-sectional view taken along a line I-I′ of FIG. 4;

FIG. 6 is an enlarged view a region A of FIG. 3; and

FIG. 7 is a diagram showing a secondary battery manufactured by a secondary battery manufacturing system according to an embodiment.

### DETAILED DESCRIPTION

The disclosure will now be described more fully with reference to the accompanying drawings, in which preferred embodiments of the disclosure are shown. Terms or words used in the present specification and claims should not be interpreted as limited to their usual or dictionary meanings, and should be interpreted conforming to the technical idea of the present disclosure based on the principle that the inventor can appropriately define the concept of the term in order to explain his or her own invention in the best way. Therefore, the embodiments described in the present specification and the configurations illustrated in the drawings are only some of the most preferred embodiments of the present disclosure and do not represent all of the technical ideas of the present disclosure, and it should be understood that there may be various equivalents and modified examples that can replace them at the time of filing this application.

In addition, it will be further understood that the terms “comprise, include” and/or “comprising, including” used herein specify the presence of stated shapes, numbers, operations, parts, elements, and/or groups thereof, but do not preclude the presence or addition of one or more other shapes, numbers, operations, parts, elements, and/or groups thereof.

Also, to aid understanding of the disclosure, the accompanying drawings are not drawn to actual scale and the dimensions of some components may be exaggerated. In addition, the same reference numerals may be assigned to the same components in different embodiments.

When it is said that two objects to be compared are ‘identical,’ it is meant that the two objects are ‘substantially identical.’ Therefore, substantial identicalness may include deviations that are considered low in the art, for example, deviations within 5%. In addition, uniformity of a parameter over a certain region may imply uniformity from an average perspective.

Although the terms as “first,” “second,” etc., may be used to describe various components, such components must not be limited to the above terms. These terms are used only to distinguish one component from another, and unless otherwise specifically stated, it is to be understood that a first component may also be a second component.

Throughout the specification, unless otherwise specifically stated, each component may be singular or plural.

In the case where a component is described as being placed “on ˜(or below ˜)” or “on the top of ˜(or below ˜)” another component, it may mean the other component is placed in contact with the upper surface (or the lower surface) of the component, as well as that other components may be arranged between the component and the other component placed on (or below) the component.

In an embodiment, in case that it is described that a component is “linked,” “coupled,” or “connected” to another component, it should be understood that the components may be directly linked or connected to one another, but that other components may also be “interposed” between the components, or that each component may be “linked,” “coupled,” or “connected” through other components. Also, when it is said that a part is electrically coupled to another part, this includes not only cases where the parts are directly connected to each other, but also cases where the parts are connected to each other with another element therebetween.

In the specification, when it is described as “A and/or B,” this means A, B, or A and B, unless otherwise specified. That is, “and/or” includes all or any combination of the listed items. When it is described as “C to D,” this means C or more and D or less, unless otherwise specified.

In the specification, “electrode slurry” may be interpreted as a slurry for manufacturing an electrode of a secondary battery. For example, the electrode slurry may be sprayed/coated on an electrode substrate, such as aluminum or copper foil, to form a thin layer on one surface of the electrode substrate to manufacture an electrode assembly for a secondary battery.

An electrode slurry storage device 20 according to an embodiment may stir the electrode slurry S or raise or maintain the temperature of the electrode slurry S to a preset temperature. However, the present disclosure is not limited to such embodiments, and the electrode slurry storage device 20 may be used to store a liquid or slurry that is used in the manufacture of a secondary battery.

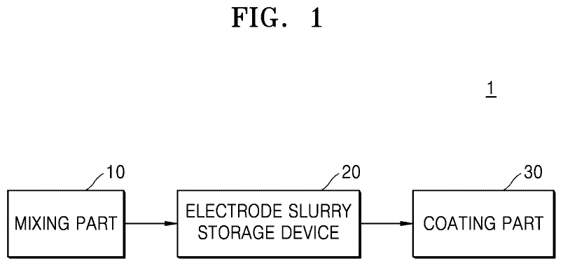

FIG. 1 is a block diagram schematically illustrating a secondary battery manufacturing system 1 according to an embodiment. Referring to FIG. 1, the secondary battery manufacturing system 1 according to an embodiment performs a process of manufacturing the electrode slurry S and coating the electrode slurry S on a substrate. The system 1 may include a mixing part 10, the electrode slurry storage device 20, and a coating part 30.

The mixing part 10 is a device that produces the electrode slurry S by mixing active materials, conductive materials, binders, solvents, or the like. The mixing part 10 may uniformly disperse the materials forming the electrode slurry S and maintain the viscosity of the electrode slurry S at a preset viscosity.

The active materials may include lithium cobalt oxide (LiCoO₂), lithium iron phosphate (LiFePO₄), lithium manganese oxide (LMO), graphite, silicon (Si), lithium titanate (LTO), or the like.

The conductive materials may include carbon black, carbon nanotubes (CNT), graphene, or the like. The binders may include polyvinylidene fluoride (PVDF), carboxymethyl cellulose (CMC), styrene-butadiene rubber (SBR), or the like. The solvents may include N-methyl-2-pyrrolidone (NMP), water, or the like.

The mixing part 10 and the electrode slurry storage device 20 may be connected by a flow path or the like such that the electrode slurry storage device 20 may receive the electrode slurry S mixed and manufactured in the mixing part 10 through the flow path.

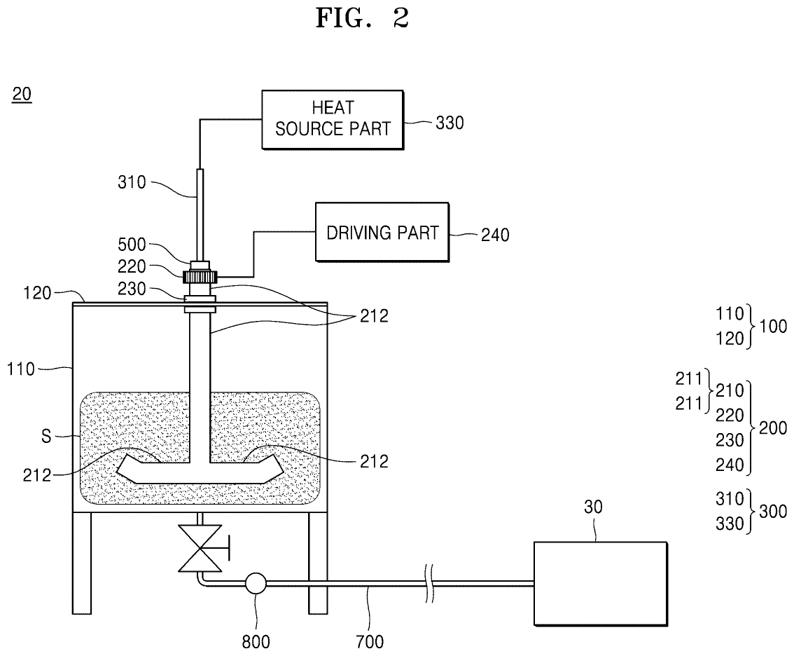

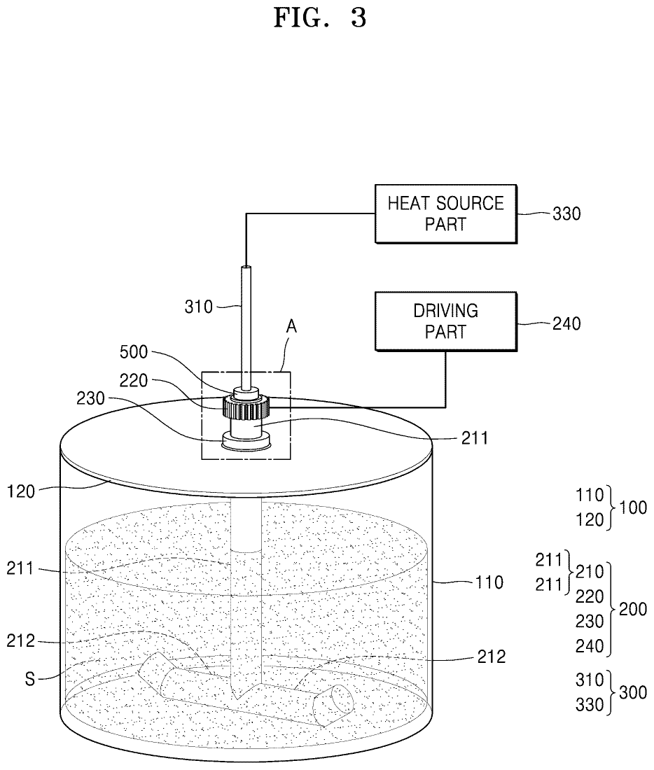

FIG. 2 is a schematic diagram of the electrode slurry storage device 20 and the coating part 30 illustrated in FIG. 1. FIG. 3 is a perspective view of the electrode slurry storage device 20 illustrated in FIG. 2.

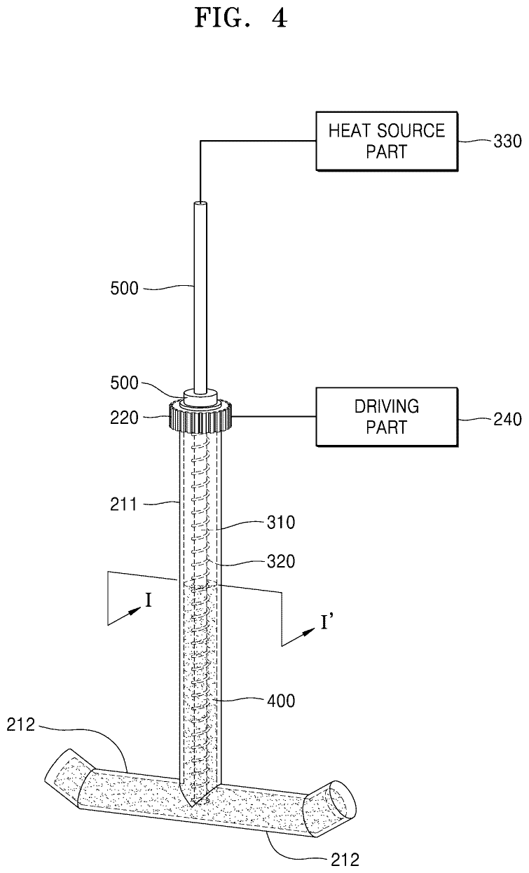

Referring to FIGS. 2 and 3, the electrode slurry storage device 20 according to an embodiment is a device that stirs the electrode slurry S and raises or maintains the temperature of the electrode slurry S to a preset temperature range. The electrode slurry storage device 20 may include a chamber part 100, a rotating part 200, a heating part 300, an operating fluid 400 (refer to FIG. 4), a sealing part 500, a valve part 600, a flow path part 700, and a sensor part 800.

The chamber part 100 according to an embodiment is capable of accommodating the electrode slurry S and may include a chamber body 110 and a cover body 120. The chamber body 110 may provide a space in which the electrode slurry S is accommodated and may be formed in a shape of a container with one surface open. The cover body 120 may be detachably coupled to an opening of the chamber body 110. As the cover body 120 is coupled to the opening of the chamber body 110, an internal area of the chamber body 110 where the electrode slurry S is accommodated may be a sealed area.

The chamber body 110 may include an insulating material. For example, the chamber body 110 may include at least one of stainless steel, aluminum, polyurethane, ceramic, glass fiber, polystyrene, tungsten, carbon foam, titanium, and aramid fiber.

The chamber body 110 may include a transparent or semi-transparent material. Accordingly, the degree of stirring and the degree of sediment of the electrode slurry S accommodated inside the chamber body 110 may be easily checked in real time.

The chamber body 110 may include a multi-wall container. For example, the chamber body 110 may include a multi-wall container including an inner wall and an outer wall of the chamber body 110. A space between the inner wall and the outer wall may be formed as a sealed area, and an air layer or an insulating material may be arranged between the inner wall and the outer wall of the chamber body 110. Accordingly, heat from a heat source of the electrode slurry S is better contained in the chamber body 110 because of the low thermal conductivity of the air layer or the insulating material between the inner wall and the outer wall of the chamber body 110. Thus, the temperature of the electrode slurry S may be effectively increased or maintained.

Referring to FIG. 2, the chamber body 110 may be connected to the flow path part 700 (described below_, and the flow path part 700 may connect the chamber body 110 and the coating part 30 to each other. For example, the internal area of the chamber body 110 may be in communication with the coating part 30 through the flow path part 700. Thus, the electrode slurry S located inside the chamber body 110 may be supplied to the coating part 30 through the flow path part 700.

Referring to FIGS. 2 and 3, the cover body 120 according to an embodiment covers an opening of the chamber body 110 and may be detachably connected to one surface of the chamber body 110.

Referring to FIG. 3, the rotating part 200 may be rotatably connected to the cover body 120. For example, a hole may be formed in the cover body 120, and the rotating part 200 may extend through the hole and be rotatably connected to the cover body 120. By separating the cover body 120 from the chamber body 110, the rotating part 200 and the heating part 300 may be separated from the chamber body 110. This configuration facilitates repair or replacement of the rotating part 200 or the heating part 300.

In an optional embodiment, the rotating part 200 may be rotatably connected to the chamber body 110 and may be arranged to be spaced apart from the cover body 120.

The cover body 120 may include an insulating material. For example, the cover body 120 may include at least one of stainless steel, aluminum, polyurethane, ceramic, glass fiber, polystyrene, tungsten, carbon foam, titanium, and aramid fiber. The cover body 120 may include a transparent or semi-transparent material. Thus, a user can easily check in real time the degree of stirring and the amount of sediment of the electrode slurry S accommodated inside the chamber body 110 through the cover body 120. The cover body 120 may also include a multi-wall plate. For example, the cover body 120 may include a plate assembly having a shape in which two plates are stacked, with a space between the two plates may be formed as a sealed area, and with an air layer or an insulating material being arranged in the space between the two plates.

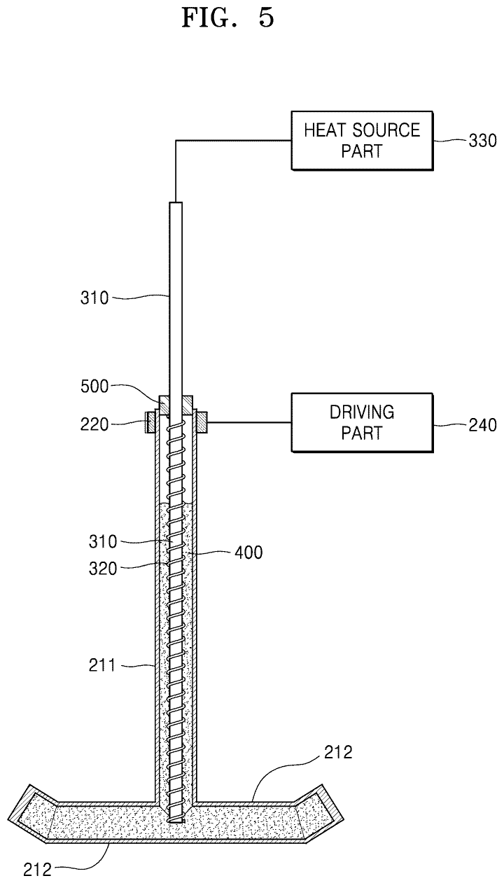

FIG. 3 is a perspective view of the electrode slurry storage device 20 illustrated in FIG. 2. FIG. 4 is a perspective view showing an assembled state of the rotating part 200, the heating part 300, the operating fluid 400, and the sealing part 500 shown in FIG. 3. FIG. 5 is a cross-sectional view taken along a line I-I′ of FIG. 4.

Referring to FIGS. 2 to 4, the rotating part 200 according to an embodiment is configured to stir the electrode slurry S and may include a rotating body 210, a power transmission part 220, a connecting part 230, and a driving part 240.

Referring to FIGS. 2 and 3, one side of the rotating part 200 is arranged inside the chamber part 100, and the rotating part 200 may rotate around a preset axis. For example, the rotating part 200 may extend through the cover body 120 such that a first end portion of the rotating part 200 is arranged in the internal area of the chamber body 110. A second end portion of the rotating part 200, which is opposite to the first end portion, may be arranged outside the chamber body 110.

A longitudinal central axis of the rotating part 200 may be coaxial with a longitudinal central axis of the chamber part 100. For example, the longitudinal central axis of the rotating part 200 may pass through a central portion of the cover body 120 such that the longitudinal central axis of the rotating part 200 may be coaxial with a longitudinal central axis of the chamber body 110. Further, a rotation center axis of the rotating part 200 may pass through the central portion of the cover body 120, and the rotation center axis of the rotating part 200 may be coaxial with the longitudinal central axis of the chamber body 110.

The rotating part 200 may be hollow. As such, the heating part (heater) 300 and the operating fluid 400 may be accommodated in an internal area of the rotating part 200. With this configuration, the operating fluid 400 may receive heat from the heating part 300 in the internal area of the rotating part 200. The operating fluid 400 provided with the heat source may transmit the heat to the rotating part 200. Accordingly, the rotating part 200 is heated and may transmit heat to the electrode slurry S while stirring the electrode slurry S. Thus, the temperature of the electrode slurry S may be increased to a preset temperature or maintained at a preset temperature while being stirred inside the chamber part 100.

Referring to FIGS. 4 and 5, the rotating body 210 according to an embodiment is configured to stir the electrode slurry S located inside the chamber part 100. The rotating body 210 may include a cylinder part 211 and a wing part 212. The rotating body 210 is hollow and may accommodate the operating fluid 400 in its hollow space. In the depicted example, the rotating body 210 is formed in a ‘T’ shape and includes a space to accommodate the operating fluid 400. The rotating body 210 may be rotatably connected to the chamber part 100. And the rotating body 210 may be rotatably connected to the cover body 120 or the chamber body 110 through the connecting part 230.

In examples, the connecting part 230 is formed as bearing having an inner ring and an outer ring that may rotate relative to each other. The rotating body 210 may be connected to the outer ring of the connecting part 230. The chamber part 100 may be connected to the inner ring of the connecting part 230. Thus, the rotating body 210 may rotate about a preset axis with respect to the chamber part 100 through the connecting part 230. As the rotating body 210 rotates with respect to the chamber part 100 it stirs the electrode slurry S accommodated inside the chamber part 100.

The rotating body 210 may extend through a hole formed in the cover body 120. The connecting part 230 may be arranged between an inner periphery surface of the hole formed in the cover body 120 and an outer periphery surface of the rotating body 210. For example, the rotating body 21 may be fixed to the connecting part 230. But the present disclosure is not limited to such a configuration, and the rotating body 210 may be rotatably connected to the connecting part 230.

The rotating body 210 may be connected to the power transmission part 220. The power transmission part 220 may receive power from the driving part 240, and the power transmission part 220 may transmit the power to the rotating body 210. Accordingly, the rotating body 210 may receive power from the power transmission part 220, which causes the rotating body 210 to rotate.

The rotating body 210 may accommodate the heating part 300 therein, and an inner periphery surface of the rotating body 210 may be spaced apart from the heating part 300. The operating fluid 400 may be positioned between the inner periphery surface of the rotating body 210 and the heating part 300. With such a configuration, the rotating body 210 comes into contacts and directly receives heat from the heating part 300. As such, the rotating body 210 is not excessively heated, the durability of the rotating body 210 is maintained, and the electrode slurry S is not excessively heated. This may be contrasted to a configuration where the rotating body 210 receives power from the outside and rotates, in which case the heating part 300 receives frictional force from the rotating body 210 and may thereby be damaged.

As an optional embodiment, the inner periphery surface of the rotating body 210 and the heating part 300 may be in a sliding contact. In this case, the operating fluid 400 may act as a lubricant between the inner periphery surface of the rotating body 210 and the heating part 300. Thus, damage to the heating part 300 due to the frictional force of the rotating body 210 may be reduced, and the heating part 300 may effectively transmit heat to the rotating body 210.

Referring to FIGS. 4 and 5, the cylinder part 211 according to an embodiment may extend along a preset axis and may be connected to the chamber part 100. The cylinder part 211 may be hollow. A first end portion of the cylinder part 211 may be connected to the wing part 212 inside the chamber part 100. A second end portion of the cylinder part 211, which is opposite to the first end portion, may be arranged outside the chamber part 100. A longitudinal central axis of the cylinder part 211 may be coaxial with the longitudinal central axis of the chamber part 100. For example, the longitudinal central axis of the cylinder part 211 may pass through the central portion of the cover body 120 such that the longitudinal central axis of the cylinder part 211 may be coaxial with the longitudinal central axis of the chamber body 110.

The cylinder part 211 may be formed in a shape of a linear cylinder. The wing part 212 may be integrally connected to the end portion of the cylinder part 211 that is adjacent to a bottom portion of the chamber part 100. An internal area of the cylinder part 211 may be in fluid communication with an internal area of the wing part 212. Thus, the operating fluid 400 may be accommodated between the internal area of the wing part 212 and the internal area of the cylinder part 211.

The rotating body 210 may be formed as a blade in the shape of a ‘T’ with a hollow interior. In embodiments of the present disclosure, the cylinder part 211 and the wing part 212 may be interpreted as different areas of the rotating body 210. For example, the cylinder part 211 may be interpreted as an area extending along the rotation center axis of the rotating body 210, and the wing part 212 may be interpreted as an area extending in a radial direction from the rotation center axis of the rotating body 210. While the cylinder part 211 and the wing part 212 may be integrally formed, but the present disclosure is not limited to such a configuration. For example, the cylinder part 211 and the wing part 212 may be detachably connected to each other.

The cylinder part 211 may be rotatably connected to the cover body 120. In particular, an outer periphery surface of the cylinder part 211 may be rotatably connected to the cover body 120 through the connecting part 230. For example, the connecting part 230 may be formed as a bearing having an inner ring and an outer ring that may rotate relative to each other. The outer periphery surface of the cylinder part 211 may be connected to the outer ring of the connecting part 230, and the cover body 120 may be connected to the inner ring of the connecting part 230. Thus, the cylinder part 211 may rotate around a preset axis with respect to the cover body 120. And as a result, when the cylinder part 211 rotates relative to the cover body 120 it may stir the electrode slurry S accommodated inside the chamber body 110.

The cylinder part 211 may extend through a hole formed in the cover body 120. The connecting part 230 may be arranged between an inner periphery surface of the hole formed in the cover body 120 and an outer periphery surface of the cylinder part 211. The cylinder part 211 may be connected to the power transmission part 220. The power transmission part 220 may receive power from the driving part 240 and the power transmission part 220 may transmit the power received from the driving part 240 to the cylinder part 211. Thus, the cylinder part 211 may be rotated by the power received from the power transmission part 220.

The cylinder part 211 may accommodate the heating part 300 therein, with the inner periphery surface of the cylinder part 211 being spaced apart from the heating part 300 by a preset distance. The operating fluid 400 may be positioned between the inner periphery surface of the cylinder part 211 and the heating part 300. Thus, the cylinder part 211 receives heat directly from the heating part 300. This configuration prevents excessive heating of the cylinder part 211, which would other reduce the durability of the cylinder part 211 and cause the electrode slurry S to be excessively heated.

In another embodiment, the inner periphery surface of the cylinder part 211 and the heating part 300 may be in a sliding contact. In this configuration, the operating fluid 400 may act as a lubricant between the inner periphery surface of the cylinder part 211 and the heating part 300 so that damage to the heating part 300 due to the frictional force of the cylinder part 211 is reduced and the heating part 300 may effectively transmit heat to the cylinder part 211.

Referring to FIGS. 2 to 5, the wing part 212 according to an embodiment is configured to receive a rotational force from a cylinder part 211 and thereby stir the electrode slurry S. The wing part 212 may be connected to the cylinder part 211 and extend in a direction away from the longitudinal central axis of the cylinder part 211. In other words, the wing part 212 is a blade of the rotating body 210 and may extend away from the outer periphery surface of the cylinder part 211 based on the rotation center axis of the rotating body 210.

The wing part 212 may be hollow and an internal area of the wing part 212 may be in fluid communication with the internal area of the cylinder part 211. A longitudinal central axis of the wing part 212 may form a preset angle with the longitudinal central axis of the cylinder part 211. For example, the longitudinal central axis of the wing part 212 may be orthogonal to the longitudinal central axis of the cylinder part 211. The ‘internal space of the wing part 212’ is an area in the rotating body 210 that is located further away from the rotation center axis of the rotating body 210 than the radius of the cylinder part 211. For example, the shortest distance between the internal space of the wing part 212 and the rotation center axis of the rotating body 210 may be equal to or similar to the outer diameter of the cylinder part 211.

The wing part 212 may be arranged to be spaced apart from the heating part 300 by a preset distance. More specifically, the internal space of the wing part 212 may accommodate the operating fluid 400, and the internal space of the wing part 212 and the heating part 300 may be arranged to be spaced apart from each other by a preset distance. With this configuration, the heating part 300 is arranged at the rotation center axis of the rotating body 210 and not in the internal space of the wing part 212. Thus, even when the rotating body 210 rotates, the heating part 300 may remain stationary and not rotate about the rotation center axis of the rotating body 210. Accordingly, a heating wire 320 or electric wires provided in the heating part 300 are not twisted or damaged.

Referring to FIGS. 4 and 5, the operating fluid 400 is accommodated in the internal area of the rotating body 210, specifically, in a sealed area formed by the inner periphery surface of the heating part 300 and the inner periphery surface of the cylinder part 211. The heating part 300 may be spaced from the internal area of the wing part 212 while facing the inner periphery surface of the cylinder part 211. As such, a side of the heating part 300 may be immersed in the operating fluid 400 accommodated in the sealed area. When the heating part 300 receives power from the outside to generate heat, the operating fluid 400 in which the heating part 300 is immersed may be heated up or maintained at a preset temperature by receiving the heat from the heating part 300. And the rotating body 210 that accommodates the operating fluid 400 may be heated up or maintained at a preset temperature by receiving the heat from the operating fluid 400. Thus, the electrode slurry S that contacts the rotating body 210 and is stirred by the rotational force of the rotating body 210 may be heated up or maintained at a preset temperature by receiving the heat from the rotating body 210.

Referring to FIGS. 3 to 5, the power transmission part 220 according to an embodiment is configured to receive power from outside and transmit the power to the rotating body 210. The power transmission part 220 may be connected to one side of the rotating body 210. In particular, the power transmission part 220 may be connected to the outer periphery surface of the rotating body 210 and may be arranged outside of the chamber part 100. For example, the power transmission part 220 may be located at an end portion of the rotating body 210 that is located outside of the chamber part 100.

Referring to FIG. 4, the power transmission part 220 may be a gear. For example, the power transmission part 220 may be a gear that is fixed to the outer periphery surface of the rotating body 210 and rotates coaxially with the rotation center axis of the rotating body 210. However, the disclosure is not limited to this configuration. For example, the power transmission part 220 may be integrally formed with the rotating body 210, with the power transmission part 220 functioning as a gear formed on the outer periphery surface of the rotating body 210 functions.

An outer periphery surface of the power transmission part 220 may be meshed and/or connected to the driving part 240, and an inner periphery surface of the power transmission part 220 may be fixed to the rotating body 210. Accordingly, when the power transmission part 220 receives power from the driving part 240 and rotates, the rotating body 210 rotates integrally with the power transmission part 220 so that the electrode slurry S in which the rotating body 210 is immersed may be stirred.

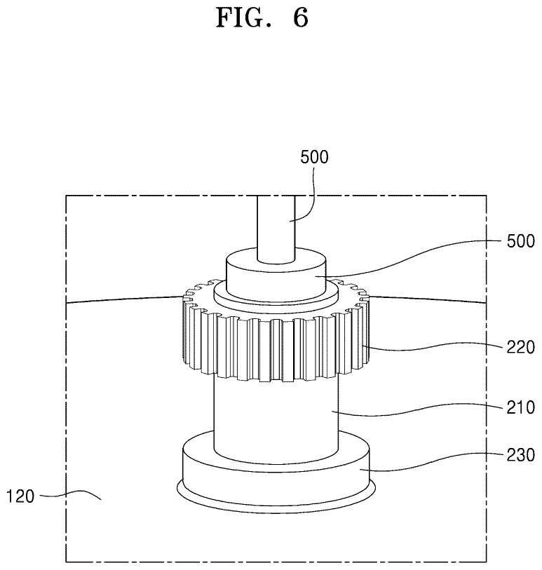

Referring to FIGS. 2, 3, and 6, the connecting part 230 according to an embodiment is configured to connect the rotating body 210 and the chamber part 100 to each other, and the connecting part 230 may be positioned between the outer periphery surface of the rotating body 210 and the inner periphery surface of the cover body 120. For example, the connecting part 230 may be a bearing having an inner ring and an outer ring that may rotate relative to each other. The inner ring of the connecting part 230 may be connected to the rotating body 210, and the outer ring of the connecting part 230 may be connected to the cover body 120.

The connecting part 230 may include various devices so that the rotating body 210 and the chamber part 100 may rotate stably relative to each other. For example, the connecting part 230 may include at least one of a sleeve bearing, a ball bearing, a fluid bearing, a sleeve bearing, a slip ring, a universal joint, a swivel joint, a coupling structure, a gear system, a flywheel, or a lubricating member.

Referring again to FIGS. 4 and 5, the driving part 240 according to an embodiment is configured to receive power supply from outside to generate power, and the driving part may be connected to the power transmission part 220 to provide power to the power transmission part 220. In particular, the driving part 240 may be meshed and/or connected to the power transmission part 220 and apply a rotational force to the power transmission part 220. But the present disclosure is not limited to this configuration, and the driving part 240 may include various devices that may receive power and rotate the rotating body 210 through the power transmission part 220.

Referring to FIGS. 2 to 6, the heating part 300 according to an embodiment is configured to provide a heat source to the interior of the rotating part 200 and may include a heating rod 310, the heating wire 320, and a heat source part 330.

Referring to FIGS. 4 and 5, the heating part 300 has one side accommodated inside the rotating body 210 and another side that is different from the one side may be exposed to the outside of the rotating body 210 and the outside of the chamber part 100. The heating part 300 may be fixed inside the rotating body 210. For example, the heating part 300 may be fixed to an external device so that rotation thereof may be restricted regardless of a rotational motion of the rotating part 200. The heating part 300 may be spaced apart from the rotating body 210 by a preset distance, so that the rotational motion of the rotating part 200 may not affect the heating part 300.

The rotating body 210 may rotate relative to the heating part 300. That is, the rotating part 200 may rotate independently while the position or posture of the heating part 300 is fixed. When the rotating body 210 rotates, the operating fluid 400 accommodated in the rotating body 210 may rotate together with the rotating body 210. And the heating part 300 may maintain a stationary state regardless of the rotation of the rotating body 210. Accordingly, the operating fluid 400 may transmit heat supplied from the heating part 300 to the rotating body 210 so that even when the heating part 300 does not rotate, the heat supplied from the heating part 300 may be transmitted to the rotating body 210 through the operating fluid 400.

With the depicted configuration, even when the rotating body 210 rotates, the heating wire 320 or electric wire of the heating part 300 are not twisted or damaged. Further, the heat supplied from the heating part 300 may be stably transmitted to the rotating body 210 through the operating fluid 400. Thus, the temperature of the electrode slurry S in contact with the rotating body 210 may be increased or maintained at a preset temperature.

Referring again to FIGS. 4 and 5, the heating rod 310 according to an embodiment of is configured to receive power and to provide heat to the operating fluid 400. The heating rod 310 may be arranged inside the rotating body 210. In particular, the heating rod 310 may be formed in the shape of a rod, and the longitudinal central axis of the heating rod 310 may be coaxial to or parallel to the longitudinal central axis of the rotating body 210.

In other words, the heating rod 310 can be formed in the shape of a rod of which the longitudinal central axis is coaxial to or parallel to the rotation center axis of the rotating body 210.

The heating rod 310 may receive power supply or a heat source from the outside and supply the heat to the inside of the rotating body 210. For example, the heating rod 310 may receive power and/or heat from the heat source part 330 and thereby supply heat to the inside of the rotating body 210.

A diameter of the heating rod 310 may be less than an inner diameter of the cylinder part 211, and the operating fluid 400 may be accommodated between an outer periphery surface of the heating rod 310 and the inner periphery surface of the cylinder part 211.

The heating rod 310 may include various devices that are able to supply heat to the inside of the rotating body 210 by receiving power and/or heat from outside, such as a heater rod or the like.

Referring to FIGS. 4 and 5, in an embodiment, the heating wire 320 is configured to receive power and/or heat and supply heat to the operating fluid 400. The heating wire 320 may be wound around the heating rod 310. In particular, the heating wire 320 may be wound around the outer periphery surface of the heating rod 310 along the longitudinal central axis of the heating rod 310. Thus, the heating wire 320 may be fixedly supported by the heating rod 310. The heating wire 320 may be in contact with the outer periphery surface of the heating rod 310, and the heating wire 320 may be spaced apart from the inner periphery surface of the rotating body 210 by a preset distance. In this case, the operating fluid 400 may be accommodated between the heating wire 320 and the rotating body 210. However, the disclosure is not limited to this configuration, and the heating wire 320 may be in sliding contact with the inner periphery surface of the rotating body 210.

An area of the heating rod 310 around which the heating wire 320 is wound may be limited to an area of the heating rod 310 that is immersed in the operating fluid 400. For example, a position of the heating wire 320 wound around the heating rod 310 may overlap the area where the operating fluid 400 is positioned.

A distance from the rotation center axis of the rotating body 210 to the heating wire 320 may be less than a distance from the rotation center axis of the rotating body 210 to the inner periphery surface of the rotating body 210.

The heating wire 320 may be spaced from the internal area of the wing part 212 by a preset distance. Thus, rotation of the wing part 212 does not affect the heating wire 320. That is, when the wing part 212 rotates, the heating wire 320 is not twisted or damaged.

The heating wire 320 may include various devices that are wound around the heating rod 310 by being bent and may receive power and/or heat and supply the heat to the operating fluid 400. For example, the heating wire 320 may include at least one of a nichrome wire, a carbon heating element, a positive temperature coefficient (PTC) element, a silicone heating cable, a metal foil heating element, a carbon nanotube (CNT) heating element, and a halogen heating element.

Referring to FIGS. 2 to 5, the heat source part 330 according to an embodiment is configured to supply a heat and/or power to the heating rod 310 and/or the heating wire 320. The heat source part 330 may be connected to the heating rod 310 and/or or the heating wire 320. For example, the heat source part 330 may be in contact with the heating rod 310 or the heating wire 320 to heat the heating rod 310 or the heating wire 320. But the present disclosure is not limited to such a configuration. The heat source part 330 may heat the heating rod 310 or the heating wire 320 in a non-contact manner, such as by induction magnetic force.

Referring to FIGS. 4 and 5, the operating fluid 400 according to an embodiment is configured to transmit heat provided by the heating part 300 to the rotating body 210. The operating fluid 400 may be a fluid or slurry that may flow within the rotating part 200. The operating fluid 400 may be in contact with the heating part 300, and specifically, the heating part 300 may be in contact with the outer periphery surface of at least one of the heating rod 310 and the heating wire 320. Accordingly, the operating fluid 400 may receive heat from at least one of the heating rod 310 and the heating wire 320 and transmit the heat to the rotating body 210. In particular embodiments, the operating fluid 400 may include a fluid or slurry having high thermal conductivity. For example, the operating fluid 400 may include water, an ethylene glycol mixture, oil, freon, a refrigerant, mercury, sodium, potassium, or the like.

Referring to FIGS. 2 to 6, the sealing part 500 according to an embodiment of is configured to seal the internal area of the rotating body 210 and may be arranged on an opening of the rotating body 210 into which the heating part 300 is inserted. The sealing part 500 may be arranged between the heating part 300 and the rotating part 200. For example, the sealing part 500 may be arranged in a space between the outer periphery surface of the heating rod 310 and the inner periphery surface of the cylinder part 211. The sealing part 500 may be in contact with the inner periphery surface of the opening of the rotating body 210 into which the heating part 300 is inserted, and the heating part 300 may be inserted into the interior of the rotating body 210 by penetrating the sealing part 500. The sealing part 500 may be fixed on the inner periphery surface of the opening of the rotating body 210. And the sealing part 500 may be rotatably connected to the heating part 300.

In another embodiment, the sealing part 500 may be fixed to the heating part 300, and an outer periphery surface of the sealing part 500 may be in sliding contact with the inner periphery surface of the opening of the rotating body 210. Accordingly, when the rotating body 210 rotates while the heating part 300 is fixed, the sealing part 500 arranged between the heating part 300 and the rotating body 210 may seal a space between the heating part 300 and the rotating body 210 and simultaneously enable the rotating body 210 to rotate. Such a configuration prevents the operating fluid 400 accommodated inside the rotating body 210 from being discharged and enables the rotating body 210 to rotate smoothly.

The sealing part 500 may include various configurations that prevent the operating fluid 400 from being discharged through the space between the heating part 300 and the rotating body 210. For example, the sealing part 500 may include an O-ring, a gasket, a packing, a metal sealing member, a shaft seal, a retainer ring, a bellows seal, a spiral wound gasket, a polytetrafluoroethylene (PTFE) seal, or the like.

Referring to FIG. 2, the valve part 600 according to an embodiment may be arranged on a flow path part 700 that allows the chamber part 100 and the coating part 30 to be in fluid communication with each other. The valve part 600 may adjust an amount of the electrode slurry S discharged from the chamber part 100. The valve part 600 may include various devices that open and close the flow path part 700 or adjust the amount of the electrode slurry S discharged to the coating part 30.

The sensor part 800 according to an embodiment may be arranged on the flow path part 700 that allows the chamber part 100 and the coating part 30 to be in fluid communication with each other. The sensor part 800 may measure the temperature of the electrode slurry S discharged from the chamber part 100 or the temperature of the electrode slurry S accommodated inside the chamber part 100. Accordingly, the electrode slurry S may be effectively coated on an electrode substrate by appropriately adjusting the temperature of the electrode slurry S discharged to the coating part 30.

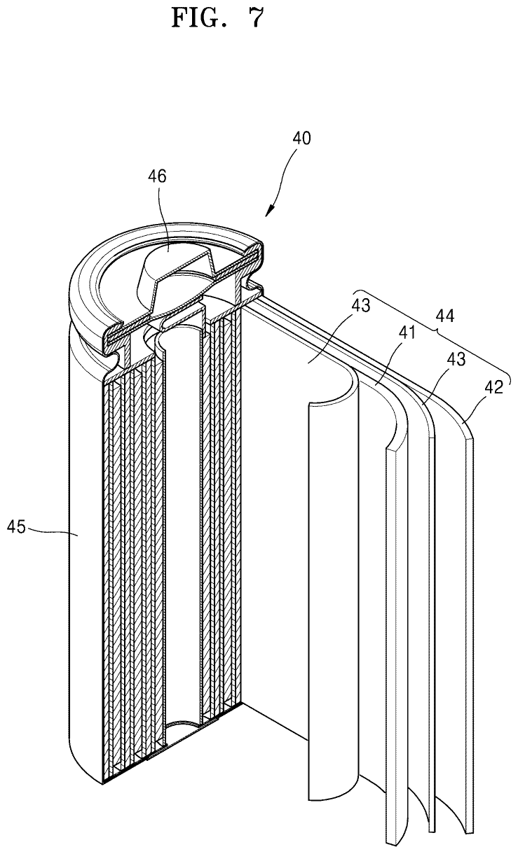

FIG. 7 is a diagram showing an embodiment of a secondary battery manufactured by a secondary battery manufacturing system according to an embodiment. In the disclosure, a secondary battery 40 may be any of a cylindrical secondary battery, a square secondary battery, and a pouch-type secondary battery.

Referring to FIG. 7, the secondary battery 40 according to an embodiment may include an electrode assembly 44 having a separator 43 interposed between a cathode 41 and an anode 42, and a case 45 in which the electrode assembly 44 is accommodated. The cathode 41, the anode 42, and the separator 43 may be impregnated with an electrolyte (not shown). The electrode assembly 44 may include a sealing member 46 that seals the case 45, as shown in FIG. 7.

The cathode 41 for a lithium secondary battery may include a current collector and a cathode active material layer formed on the current collector. The cathode active material layer includes a cathode active material and may further include a binder and/or a conductive material. The cathode 41 may further include an additive that may function as a sacrificial cathode.

The amount of the cathode active material may be about 90 wt % to about 99.5 wt % with respect to 100 wt % of the cathode active material layer. The amount each of the binder and conductive material may be about 0.5 wt % to about 5 wt % with respect to 100 wt % of the cathode active material layer.

The binder serves to attach cathode active material particles to each other and also to attach the cathode active material to the current collector. Representative examples of the binder may include, but are not limited to, polyvinyl alcohol, carboxymethyl cellulose, hydroxypropyl cellulose, diacetyl cellulose, polyvinyl chloride, carboxylated polyvinyl chloride, polyvinyl fluoride, polymers containing ethylene oxide, polyvinyl pyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, nylon, or the like.

The conductive material is used to provide conductivity to the electrodes, and any material that does not cause a chemical change in the battery and is electronically conductive may be used. Examples of the conductive material are carbon-based materials, such as natural graphite, artificial graphite, carbon black, acetylene black, Ketjen black, carbon fibers, carbon nanofibers, and carbon nanotubes; metal-based materials containing copper, nickel, aluminum, and silver in the form of metal powder or metal fibers; conductive polymers such as polyphenylene derivatives; or mixtures thereof.

Al may be used as the current collector. But the present disclosure is not limited to an Al current collector.

The anode active material may include a material capable of reversibly intercalating/de-intercalating lithium ions, lithium metal, an alloy of lithium metal, a material capable of doping and de-doping lithium, or a transition metal oxide.

The material capable of reversibly intercalating/de-intercalating lithium ions may be a carbon-based anode active material, for example, crystalline carbon, amorphous carbon, or a combination thereof. Examples of the crystalline carbon are graphite, such as natural graphite or artificial graphite in an amorphous form, a plate form, a flake form, a spherical form, or a fibrous form. Examples of the amorphous carbon may include soft carbon or hard carbon, mesophase pitch carbide, calcined coke, or the like.

As the alloy of lithium metal, an alloy of lithium and a metal selected from Na, K, Rb, Cs, Fr, Be, Mg, Ca, Sr, Si, Sb, Pb, In, Zn, Ba, Ra, Ge, Al and Sn may be used.

As the material capable of doping and de-doping lithium, a Si-based anode active material or a Sn-based anode active material may be used. The Si-based anode active material may be silicon, a silicon-carbon composite, SiOₓ (0<x<2), a Si-Q alloy or a combination thereof. In the formula, Si-Q, Q is selected from an alkali metal, an alkaline earth metal, a group 13 element, a group 14 element (excluding Si), a group 15 element, a group 16 element, a transition metal, a rare earth element, and combinations thereof. The Sn-based anode active material may be Sn, SnO₂, a Sn-based alloy, or a combination thereof.

The silicon-carbon composite may be a composite of silicon and amorphous carbon. According to an embodiment, the silicon-carbon composite may be in the form of silicon particles and amorphous carbon coated on the surfaces of the silicon particles. For example, the silicon-carbon composite may include a secondary particle (core) in which silicon primary particles are assembled and an amorphous carbon coating layer (shell) positioned on the surface of the secondary particle.

The amorphous carbon may also be positioned between the silicon primary particles. For example, the silicon primary particles may be coated with the amorphous carbon. The secondary particles may be dispersed in an amorphous carbon matrix.

The silicon-carbon composite may also further include crystalline carbon. For example, the silicon-carbon composite may include a core including crystalline carbon and silicon particles and an amorphous carbon coating layer positioned on the surface of the core.

The Si-based anode active material or the Sn-based anode active material may be mixed with a carbon-based anode active material.

The anode 42 for a lithium secondary battery includes a current collector and an anode active material layer positioned on the current collector. The anode active material layer includes an anode active material and may further include a binder and/or a conductive material. For example, the anode active material layer may include about 90 wt % to about 99 wt % of the anode active material, about 0.5 wt % to about 5 wt % of the binder, and about 0 wt % to about 5 wt % of the conductive material.

The binder serves to attach anode active material particles to each other and also to attach the anode active material to the current collector. As the binder, a non-aqueous binder, an aqueous binder, a dry binder, or a combination thereof may be used.

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamideimide, polyimide, or combinations thereof.

The aqueous binder may be selected from styrene-butadiene rubber, (meta)acrylated styrene-butadiene rubber, (meta)acrylonitrile-butadiene rubber, (meta)acrylic rubber, butyl rubber, fluoroelastomer, polyethylene oxide, polyvinylpyrrolidone, polyepichlorohydrin, polyphosphazene, poly(meta)acrylonitrile, ethylene propylene diene copolymer, polyvinyl pyridine, chlorosulfonated polyethylene, latex, polyester resin, (meta)acrylic resin, phenol resin, epoxy resin, polyvinyl alcohol, and combinations thereof.

When an aqueous binder is used as the binder of the anode, a cellulose-based compound capable of imparting viscosity may be further included. As the cellulose-based compound, a mixture of one or more types of carboxymethyl cellulose, hydroxypropyl methyl cellulose, methyl cellulose, or alkali metal salts thereof may be used. As the alkali metal, Na, K, or Li may be used.

The dry binder is a polymeric material capable of being fiberized, and may be, for example, polytetrafluoroethylene, polyvinylidene fluoride, polyvinylidene fluoride-hexafluoropropylene copolymer, polyethylene oxide, or combinations thereof.

The conductive material is used to provide conductivity to the electrodes, and any material that does not cause a chemical change in the battery and is electronically conductive may be used. Specific examples of the conductive material may include carbon-based materials, such as natural graphite, artificial graphite, carbon black, acetylene black, Ketjen black, carbon fibers, carbon nanofibers, and carbon nanotubes; metal-based materials containing copper, nickel, aluminum, and silver in the form of metal powder or metal fibers; conductive polymers such as polyphenylene derivatives; or mixtures thereof.

The current collector of the anode may be selected from a copper foil, a nickel foil, a stainless steel foil, a titanium foil, a nickel foam, a copper foam, a polymer substrate coated with a conductive metal, and a combination thereof.

An electrolyte for a lithium secondary battery includes a non-aqueous organic solvent and lithium salt. The non-aqueous organic solvent acts as a medium through which ions involved in electrochemical reactions of the battery may move. The non-aqueous organic solvent may be a carbonate-based, ester-based, ether-based, ketone-based, or alcohol-based solvent, an aprotic solvent, or a combination thereof.

As the carbonate-based solvent, dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like may be used.

As the ester-based solvent, methyl acetate, ethyl acetate, n-propyl acetate, dimethyl acetate, methyl propionate, ethyl propionate, decanolide, mevalonolactone, and valerolactone, caprolactone, or the like may be used.

As the ether-based solvent, dibutyl ether, tetraglyme, diglyme, dimethoxyethane, 2-methyltetrahydrofuran, 2,5-dimethyltetrahydrofuran, tetrahydrofuran, or the like may be used. In addition, as the ketone-based solvent, cyclohexanone or the like may be used. As the alcohol-based solvent, ethyl alcohol, isopropyl alcohol, or the like may be used, and as the aprotic solvent, nitriles such as R—CN (R is a linear, branched, or cyclic hydrocarbon group having 2 to 20 carbon atoms and may include a double bond, an aromatic ring, or an ether group); amides such as dimethylformamide; dioxolanes such as 1,3-dioxolane and 1,4-dioxolane; sulfolanes, or the like may be used.

The non-aqueous organic solvent may be used alone or in combination of two or more types of solvents.

In an embodiment where a carbonate-based solvent is used, a cyclic carbonate and a chain carbonate may be mixed and used. The cyclic carbonate and the chain carbonate may be mixed in a volume ratio of 1:1 to 1:9.

The lithium salt is a material that is dissolved in an organic solvent and acts as a source of lithium ions within the battery to enable a basic operation of a lithium secondary battery and promote a movement of lithium ions between the cathode and the anode. Representative examples of the lithium salt may include one or two of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide (LiFSI), LiC₄F₉SO₃, LiN(CₓF₂ₓ₊₁SO₂)(C_{y}F_{2y+1}SO₂) (x and y are integers from 1 to 20), lithium trifluoromethanesulfonate, lithium tetrafluoroethanesulfonate, lithium difluorobis(oxalato)phosphate (LiDFOB), and lithium bis(oxalato)borate (LiBOB).

Depending on the type of lithium secondary battery, a separator may be provided between the cathode and the anode. As such a separator, polyethylene, polypropylene, polyvinylidene fluoride or a multi-layered film of two or more layers thereof may be used, and a mixed multi-layered film, such as a polyethylene/polypropylene two-layered separator, a polyethylene/polypropylene/polyethylene three-layer separator, a polypropylene/polyethylene/polypropylene three-layered separator, or the like may be used. The separator may include a porous substrate and a coating layer including an organic material, an inorganic material, or a combination thereof, which is positioned on one surface or both surfaces of the porous substrate.

The porous substrate may be a polymer film formed of any one polymer selected from polyolefins such as polyethylene and polypropylene, polyesters such as polyethylene terephthalate and polybutylene terephthalate, polyacetal, polyamide, polyimide, polycarbonate, polyether ketone, polyarylether ketone, polyetherimide, polyamideimide, polybenzimidazole, polyether sulfone, polyphenylene oxide, cyclic olefin copolymer, polyphenylene sulfide, polyethylene naphthalate, glass fiber, Teflon, and polytetrafluoroethylene, or a copolymer or mixture of two or more thereof.

The organic material may include a polyvinylidene fluoride-based polymer or a (meta)acrylic-based polymer.

The inorganic material may include inorganic particles selected from Al2O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof, but is not limited thereto.

The organic and inorganic materials may be mixed and present in one coating layer. In other embodiments, a coating layer including an organic material and a coating layer including an inorganic material may be stacked.

Hereinafter, operating principles and effects of the electrode slurry storage device 20 according to embodiments are described. The descriptions of the operating principles and methods are in a chronological order for convenience. But operating principles and methods described below are not limited to the order of explanation and may be performed, for example, simultaneously.

Referring to FIG. 1, the electrode slurry S may be produced by mixing preset materials in the mixing part 10. The electrode slurry S produced by mixing in the mixing part 10 may be transferred to the electrode slurry storage device 20 before being coated by the coating part 30. In particular, the electrode slurry may be stored in a preset state while being stirred or provided with a heat source in the electrode slurry storage device 20.

The electrode slurry S stored in the electrode slurry storage device 20 may be transferred to the coating part 30 through the flow path part 700. Then, the electrode slurry S may be sprayed onto an electrode substrate by the coating part 30 to manufacture an electrode for a secondary battery.

Referring to FIG. 2 and FIG. 3, the electrode slurry S produced by mixing in the mixing part 10 may be accommodated in the chamber part 100. The rotating part 200 that stirs the electrode slurry S may be arranged inside the chamber part 100. As discussed above, the rotating part 200 may include the rotating body 210, the power transmission part 220, the connecting part 230, and the driving part 240. The rotating body 210 may receive power from the driving part 240 through the power transmission part 220. Thus, the rotating body 210 may stir the electrode slurry S while rotating around an axis inside the chamber part 100.

The operating fluid 400 may be accommodated inside the rotating body 210. The operating fluid 400 may receive heat from the heating part 300 and transmit the heat to the rotating body 210.

The rotating body 210 may be arranged to penetrate the chamber part 100, and the power transmission part 220 may be connected to a side of the rotating body 210 positioned outside the chamber part 100. Accordingly, the driving part 240 positioned outside the chamber part 100 may provide power to the rotating body 210 through the power transmission part 220.

The connecting part 230 may be arranged between the rotating body 210 and the chamber part 100. In an embodiment, the rotating body 210 may be arranged to penetrate a hole portion formed in the chamber part 100. The connecting part 230 may be arranged between an inner periphery surface of the hole portion of the chamber part 100 and the outer periphery surface of the rotating body 210.

The connecting part 230 may include a member, such as a bearing, that allows the rotating body 210 to rotate smoothly with respect to the chamber part 100. And the rotating body 210 may be rotatably connected to the chamber part 100 through the connecting part 230.

The heating part 300 may be arranged inside the rotating body 210, and the heating part 300 may include the heating rod 310, the heating wire 320, and the heat source part 330, as described above.

The heating rod 310 may be arranged inside the rotating body 210 along a longitudinal direction of the rotating body 210. The heating wire 320 may be wound around an outer periphery surface of the heating rod 310.

The heating rod 310 and the heating wire 320 may be immersed in the operating fluid 400 accommodated inside the rotating body 210. Thus, heat supplied by the heating rod 310 and the heating wire 320 may increase the temperature of the operating fluid 400 or maintain the operating fluid 400 at a preset temperature. Accordingly, the operating fluid 400 may increase the temperature of the rotating body 210 or the temperature of the operating fluid 400 may be maintained at a preset temperature. Thus, the rotating body 210 may increase the temperature of the electrode slurry S while stirring the electrode slurry S or the temperature of the operating fluid 400 may be maintained at a preset temperature.

The rotating body 210 may include the cylinder part 211 extending along the rotation center axis of the rotating body 210 and the wing part 212 extending in a radial direction from the cylinder part 211, as described above. The heating rod 310 and the heating wire 320 may be arranged only in an internal area of the cylinder part 211 and may be spaced apart from an internal area of the wing part 212. Accordingly, when the rotating body 210 rotates the heating rod 310 and the heating wire 320 are not affected. Thus, the heating rod 310 and the heating wire 320 are not twisted or damaged.

In addition, while the rotating body 210 rotates, the heating part 300 may be fixed inside the rotating body 210 regardless of the rotation of the rotating body 210. And the heating part 300 inside the rotating body 210 may supply heat to the operating fluid 400, and the operating fluid 400 may transmit the heat to the rotating body 210. Accordingly, heat may be stably transmitted to the rotating body 210 by the operating fluid 400 without the heating rod 310 or the heating wire 320 being rotated or twisted, and the rotating body 210 may transmit the heat source received from the heating part 300 and the operating fluid 400 to the electrode slurry S while stirring the electrode slurry S. Thus, the temperature of the electrode slurry S is increased or maintained while stirring the electrode slurry S.

According to embodiments, an electrode slurry storage device is arranged with a heating part that supplies heat inside a rotating part that stirs a slurry so that the slurry receives heat from the heating part and it thereby not solidified.

However, the effects obtainable through the disclosure are not limited to the effects described above, and other technical effects not mentioned will be clearly understood by those skilled in the art from the description of the disclosure described below.

Each of the embodiments described above may be implemented independently, but the structure of each embodiment may be applied in combination to other embodiments.

Although the disclosure has been described with reference to the embodiments shown in the drawings, these are merely examples, and those skilled in the art will understand that various modifications and equivalent other embodiments are possible therefrom.

Specific implementations described in embodiments are intended to be illustrative only and do not limit the scope of the embodiments in any way. In an embodiment, in case that there is no specific mention such as “essential” or “importantly,” it may not be a component absolutely necessary for the application of the disclosure.

The use of the term “above” and similar referential terms in the specification of embodiments (especially in the claims) may refer to both the singular and the plural. In an embodiment, in case that a range is described in an embodiment, it is considered that the disclosure includes an individual value that falls within the range (unless otherwise stated), and it is the same as describing each individual value that constitutes the range in the detailed description. Finally, unless there is an explicit description of the order or contrary description for the operations constituting the method according to the embodiment, the operations may be performed in any suitable order. The embodiments are not necessarily limited to the order in which the above operations are described. Any use of examples or exemplary terms in embodiments is merely intended to elaborate the embodiments and is not intended to limit the scope of the embodiments, unless otherwise defined by the claims. Furthermore, those skilled in the art will appreciate that various modifications, combinations and variations can be made according to design conditions and factors.

What is claimed is:

1. An electrode slurry storage device comprising:
a chamber configured to accommodate an object to be mixed;
a rotating part having a side arranged inside the chamber, configured to rotate around an axis, and being hollow; and
a heater arranged inside the rotating part and configured to provide heat inside the rotating part,
wherein an operating fluid is accommodated in the rotating part, with a part of the heater being immersed in the operating fluid.

2. The electrode slurry storage device of claim 1, wherein the rotating part comprises a rotating body including (i) a cylinder part extending along the axis and connected to the chamber and (ii) a wing part connected to the cylinder part and extending in a direction away from the axis.

3. The electrode slurry storage device of claim 2, wherein the rotating body extends through a surface of the chamber and is rotatably connected to the chamber.

4. The electrode slurry storage device of claim 2, an inner periphery surface of the rotating body and the heater are spaced apart from each other.

5. The electrode slurry storage device of claim 2, an inner periphery surface of the rotating body and the heater are in sliding contact with each other.

6. The electrode slurry storage device of claim 2, wherein the heater comprises a heating rod arranged inside the rotating body and configured to receive power to thereby provide heat to the operating fluid.

7. The electrode slurry storage device of claim 6, a longitudinal central axis of the heating rod is parallel to a longitudinal central axis of the rotating body.

8. The electrode slurry storage device of claim 7, wherein a diameter of the heating rod is less than an inner diameter of the rotating body.

9. The electrode slurry storage device of claim 6, a longitudinal central axis of the heating rod is coaxial with a longitudinal central axis of the rotating body.

10. The electrode slurry storage device of claim 6, wherein the heater further comprises a heating wire wound around an outer periphery surface of the heating rod and configured to receive power to thereby provide heat to the operating fluid.

11. The electrode slurry storage device of claim 6, wherein the rotating body rotatable relative to the heating rod by receiving power.

12. The electrode slurry storage device of claim 11, wherein the heating rod is fixed inside the rotating body such that rotation of the heating rod is restricted.

13. The electrode slurry storage device of claim 2, wherein the wing part is hollow, an internal space of the wing part is in fluid communication with an internal space of the cylinder part, and the heater is spaced apart from the internal space of the wing part.

14. An electrode slurry storage device comprising:
a chamber configured to accommodate an object to be mixed;
a heater fixed inside the chamber and configured to receive power to provide heat to the object to be mixed; and
a rotating part arranged inside the chamber and surrounding the heater, the rotating part being rotatable about an axis and relative to the heater,
wherein a part of the heater is immersed in an operating fluid that is accommodated in the rotating part.

15. The electrode slurry storage device of claim 14, wherein the rotating part comprises a rotating body including (i) a cylinder part extending along the axis and connected to the chamber, and (ii) a wing part connected to the cylinder part and extending in a direction away from the axis.

16. The electrode slurry storage device of claim 15, wherein the rotating body extends through a surface of the chamber and is rotatably connected to the chamber.

17. The electrode slurry storage device of claim 15, wherein the heater includes a heating rod arranged inside the rotating body and configured to receive power to thereby provide heat to the operating fluid.

18. The electrode slurry storage device of claim 17, a longitudinal central axis of the heating rod is parallel to a longitudinal central axis of the rotating body.

19. The electrode slurry storage device of claim 18, wherein a diameter of the heating rod is less than an inner diameter of the rotating body.

20. The electrode slurry storage device of claim 15, wherein the wing part is hollow, an internal space of the wing part is in fluid communication with an internal space of the cylinder part, and the heater is spaced apart from the internal space of the wing part.
